(19) United States
(12) Patent Application Publication
(10) Pub. No.: US 2002/0007302 A1
(43) Pub. Date: Jan. 17, 2002

(54) Method and apparatus for tracking vendor compliance with purchaser guidelines and related method for the commercial distribution of software and hardware implementing same

(76) Inventors: Bruce V. Work, Sugar Land, TX (US); Eric Schwartzman, Houston, TX (US); Greg S. Holder, Sugar Land, TX (US); David Watts, Sugar Land, TX (US)

Correspondence Address: Hugh R. Kress, Winstead Sechrest & Minick P.C., 2400 Bank One Center, 910 Travis Street, Houston, TX, 77002, US

(21) Appl. No.: 09/760,556

(22) Filed: Jan. 16, 2001

Related U.S. Application Data
(60) Provisional application No. 60/187,469, filed on Mar. 6, 2000.
(60) Provisional application No. 60/205,873, filed on May 19, 2000.

(51) Int. Cl. G06F 17/60

(52) U.S. Cl. 705/10; 705/1; 705/26

(57) ABSTRACT

A method and apparatus for monitoring transactional events in a supply chain. In a preferred embodiment, a computer-based system for assessing information concerning transactional events in a supply chain is provided to detect compliance and non-compliance with rules imposed by a participant in the supply chain. In the event that a rules violation is detected, a charge-back is generated to be imposed upon the party responsible for the rules violation. Transactional information may be provided to the computer-based system by any means, including manual (keyboard) entry and transmission from scanning devices (such as radio-frequency bar-code scanners and the like, and data feed from the participant's own files). In one embodiment, the invention comprises computer software provided to parties to a supply chain by a software vendor. A practitioner of the invention may elect to provide such software to users on a low- or no-cost basis, and base remuneration for the software upon a proportion of the recovery income stream generated as a result of the issuance of chargebacks against rules violators.

### RELATED APPLICATIONS

This application claims the priority of prior provisional application Ser. No. 60/187,469 filed on Mar. 6, 2000, and of prior provisional application Ser. No. 60/205,873 filed on May 19, 2000, both of which being hereby incorporated by reference herein in their respective entireties.

### FIELD OF THE INVENTION

The present invention relates to the buying and selling of merchandise, and more particularly relates to a method and apparatus for tracking vendor compliance with purchasing guidelines established by purchasers at any of various levels of a supply chain.

### BACKGROUND OF THE INVENTION

In businesses such as retail merchandising and manufacturing, and in numerous other transactional contexts—medical supplies or government procurement, for example—it is very common for goods destined for sale at a retail level or otherwise to be provided to end-users to change hands between a succession of entities beginning with the manufacturer or originator of the goods and concluding with the ultimate retail sale or other type of distribution of the goods to the end-users or consuming public. The apparel industry is very much exemplary of such situations, and although the apparel industry shall be referred to frequently herein for the purposes of demonstrating various aspects of the invention, those of ordinary skill in the art having the benefit of the present disclosure will appreciate the applicability of the invention in many other commercial contexts.

The term “supply chain” is often used to refer to the path along which merchandise moves from its point of origin to the point of final distribution (e.g., retail sale), with a given supply chain sometimes involving more than (and sometimes many more than) merely the originator of the goods and the final distributor of the goods. That is, the term “supply chain” refers to a succession of transactions and destinations through which goods travel between a supplier and an end recipient, for example, a retailer.

Those of ordinary skill in the field of goods distribution will be familiar with the practice of establishing guidelines or “compliance rules” governing the manner in which merchandise is distributed from entity to entity within the overall supply chain. A given entity's compliance rules may dictate many different aspects of a transaction with a supplier of goods to that entity. Compliance rules may specify, to cite just a few examples, how goods are to be packaged, how goods are to be sorted, what types and quantities of goods are to be provided in a given shipment, the timing of delivery of the goods, and so on. Depending upon its size and sophistication, a given recipient may promulgate quite a large number of compliance rules. Commercial entities have been known to impose upwards of 300 compliance rules, for example. Moreover, different parties at different levels of a given supply chain may have (and indeed are quite likely to have) very different and perhaps incompatible compliance rules.

In order to motivate suppliers of goods to conform to a given set of compliance rules, the entity promulgating and enforcing the rules may offer the supplier incentives, such as monetary discounts, for compliance. Conversely, an entity in a supply chain may impose various forms of punitive sanctions, such as monetary penalties, for non-conformance with compliance rules. Such monetary penalties are sometimes referred to as “charge backs.” At levels in a supply chain wherein large volumes of goods are involved in each transaction, the economic ramifications of compliance or non-compliance with a particular set of rules can be substantial indeed.

The administrative and logistical overhead associated both with promulgating and enforcing compliance rules, and with ensuring one's compliance with another's rules, can also be substantial. Naturally, the overhead associated with compliance rules increases both with the volume of goods involved in each transaction, and with the number of different vendors with which a given entity has dealings governed by compliance rules. From the standpoint of an entity receiving goods at some point along a supply chain, however, the benefits in efficiency and profitability can nonetheless outweigh the overhead associated with establishing and enforcing compliance rules. Likewise, from the perspective of an entity supplying goods at some point along a supply chain, the economic benefits from ensuring compliance with a recipient's rules can outweigh the overhead.

### SUMMARY OF THE INVENTION

In view of the foregoing considerations, the present invention is directed to a system for tracking and monitoring vendor compliance with guidelines imposed upon distributors, senders, shippers and the like in a supply chain,. As will be apparent from the description to follow, the invention comprises not only a computer software-based system for facilitating compliance tracking and monitoring, but in a broader sense comprises a business model for enabling a practitioner of the invention to derive revenue by providing hardware and software to particular business entities poised to benefit from the capabilities of the inventive system.

In accordance with one aspect of the invention, a business model in accordance with the present invention is unique in that it involves the providing of software and hardware on a no-cost basis for the creation of the recovery income stream for entities that distribute product. The model advantageously gives a practitioner of the invention the ability to provide a service to customers for which such customers might not otherwise have resources or incentive to procure. That is, rather than charging some premium for the software in accordance with the invention, the practitioner of the present invention effectively gives it away in return for a portion of the recoveries derived from application of the software to a given transaction or sets of transactions. In addition to hardware and software, the present invention contemplates providing all maintenance, training, support and possibly system customization for low or no cost, with the practitioner similarly recovering these costs through sharing in the recoveries derived from use of the system.

In accordance with another aspect of the invention, such incremental recoveries for rules compliance and/or enforcement are advantageously likely to be higher than would otherwise have been realized without the benefit of the system in accordance with the present invention. In one embodiment, the practitioner of the present invention may provide at no or low cost not just the software itself, but also the hardware upon which the software runs, a network infrastructure for the hardware, training for the facility associates who operate the system, ongoing maintenance and support, and perhaps system customization. Training costs may include travel, personnel, and documentation.

The context in which the present invention finds application is the supply chain. As noted above, as used herein the term “supply chain” shall be understood to encompass the movement of merchandise, variously referred to as “product,” from point of origin or manufacture to the end customer. Each of the transactions or hand-offs that take place throughout the supply chain is based on a set of compliance rules. As noted above, typically such guidelines are established by the purchaser or receiver of product and these guidelines are imposed upon the vendor supplying the merchandise to the recipient.

The invention in one aspect comprises a software-based system which, in view of the rules a specific recipient has in place or desires to put in place, monitors all of the transactions in the supply chain, based on the paper trail that follows product movement, and reports whether the rules were or were not followed in a given instance. In one embodiment, the software gives users the ability to create expense offsets with noncompliance issues. As used herein, the terms “charge back” and “expense offset” will be understood to refer to a credit or payment reduction made in instances where guidelines are not followed (sometimes referred to as a “transaction failure”). For example, an entity's compliance rules might mandate that goods are to be packaged a certain way, with a certain count (quantity) and in a certain container type. If such rules are not followed in a particular transaction, then the affected recipient would be required to expend some effort to correct the compliance failure of the offending distributor before the product goes to the next step in the supply chain. The next step in the supply chain might be other intermediate suppliers or actually the end customer. In such a scenario, the recipient must make this adjustment to the product to make it proper for the next step in the supply chain and, consequently, issues a chargeback, or punitive-damage against the offender.

A software-based system in accordance with one embodiment of the invention identifies such transaction failures and provides a recipient with sufficient evidence to apply a credit or charge back to reduce the cost of goods paid to the supplier. This creates a recovery income stream and assists recipients in flowing product as intended.

Summarizing, software generally in accordance with the present invention is superimposed upon a supply chain, facilitating the monitoring of various transactions in the supply chain, identifies the rules that are established, identifies rules deviations or transaction failures, and in some cases may automatically impose a predetermined penalty level for every rules failure. In one embodiment, the software captures and tracks transactions and maintains an event history. A deduction or reduction in cost of business is created based on the events monitored. The product focus is on the identification of compliance failure events, issuance of chargebacks reflecting such failure events, and the creation of recovery income that the recipient would not otherwise have realized. It is believed that no prior art system is based on a business model where the necessary software and hardware, training, maintenance and support and so on is given to the user at low or no cost such that the software and hardware supplier is rewarded purely on the improvement in operations that results from this software.

### BRIEF DESCRIPTION OF THE DRAWINGS

The foregoing and other features and aspects of the present invention will be best understood with reference to the following a detailed description of a specific embodiment of the invention, when read in conjunction with the accompanying drawings, wherein:

FIG. 1 is a block diagram of a merchandise supply chain;

FIG. 2 is a block diagram illustrating the various components comprising a software-based compliance management system in accordance with one embodiment of the invention;

FIG. 3 is a flow diagram illustrating operation of the compliance management system from FIG. 2 in accordance with one embodiment of the invention; and

FIG. 4 is a block diagram illustrating the system architecture of a vendor-side component of the compliant management system in accordance with one embodiment of the present invention.

### DETAILED DESCRIPTION OF A SPECIFIC EMBODIMENT OF THE INVENTION

In the disclosure that follows, in the interest of clarity, not all features of actual implementations are described. It will of course be appreciated that in the development of any such actual implementation, as in any such project, numerous engineering, programming, and design decisions must be made to achieve the developers' specific goals and subgoals (e.g., compliance with system- and business-related constraints), which will vary from one implementation to another. Moreover, attention will necessarily be paid to proper programming, engineering and design practices for the environment(s) in question. It will be appreciated that such a development effort might be complex and time-consuming, but would nevertheless be a routine undertaking for those of ordinary skill in the relevant fields.

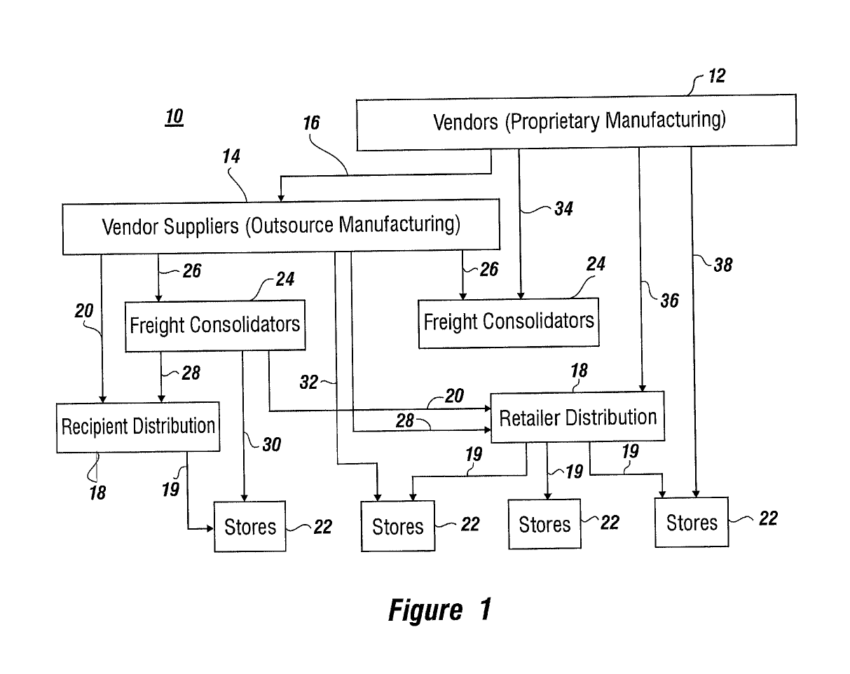

Referring to FIG. 1, there is shown a block diagram of a typical supply chain 10. As can be observed in FIG. 1, there are essentially two sources of product: First, there are those vendors or manufacturers that do their own manufacturing, such as garment manufacturers that sew garments in their own facilities. This source is represented by “proprietary manufacturing” block 12 in FIG. 1. Second, there are businesses that merely put a name brand on or design products, but outsource the actual manufacturing; this is represented by “outsource manufacturing” block in FIG. 1. Given the distinction between these types of vendors, there is a first “link” 16, between proprietary manufacturing block 12 and outsource manufacturing block 14 in FIG. 1. Link 16 reflects the fact that in some instances, there will be a first transaction between proprietary manufacturer 12 and outsource manufacturer 14. It is to be understood a transaction involving the transfer of product from one entity to another; such as link represented by link 16 in FIG. 1, represents an opportunity for transaction failures—non-compliance with guidelines—to occur. Thus, there may be compliance guidelines or rules applicable to each link in FIG. 1.

For example, the originator of product (block 12) might be a sewing plant. Such a manufacturer manufactures products for a brand name redistributor (block 14), such as Liz Claiborne or the like, which is not responsible for the manufacturing. The manufacturing occurs at a first location, and the product is shipped to the redistributor. Of course, the redistributor, as a trademark owner, is going to have very stringent requirements as to quality control, including, without limitation, the way the product is packed, how it is shipped, the way it is marked, how it is grouped, and so on. A redistributor 14 may want all of the larges for a particular style packaged together. The transaction 16 between the sewing manufacturer 12 and the redistributor 14 represents the first opportunity for the establishment of rules.

On the other hand, some redistributors also do direct manufacturing. The well-known shoe manufacturer Reebok, for example, actually direct manufactures its product; Reebok has plants in New England that actually make shoes. They take rubber, they dye the mold, they stitch it, they do their own manufacturing.

Those of ordinary skill in the art will appreciate that there are several methods for a product to ultimately get to the end user. Some of the most common methods are represented in FIG. 1. The first, going left to right in FIG. 1, is that a redistributor 14 that does not do proprietary manufacturing, ships product directly to a recipient 18, a retailer distribution center 18 in the example of FIG. 1; this transaction is represented by links 20 in FIG. 1. Recipient 18 may be any entity that distributes product to end customers by way of a retail store, as represented by links 19 in FIG. 1. The recipient 18 might be, for example, Dell Computer, the May department stores or Home Depot. Those of ordinary skill in the art will recognize that redistributors typically have facilities that are designed specifically to take in product in bulk for large categories, segregate it and send it to either the end customer directly or to a retail outlet that is going to interface with the end customer. In the Dell Computer model, for example, product goes from an overseas facility to Dell at their distribution center and then directly to a customer. Dell assembles the components to make an end product.

In a retail environment, the majority of product coming from vendors goes first to a distribution center 18 where it is sorted into an assortment for a given store, and then it is sent to the store, such as are represented by blocks 22 in FIG. 1.

Another scenario represented in FIG. 1 is one in which product comes from vendor 14 and goes to a freight consolidator 24, represented by links 26 in FIG. 1. A freight consolidator 24 is an organization that is based in areas of high production and takes small shipments from multiple vendors. Freight consolidator 24 combines the smaller shipments into one large shipment for one retailer. Such consolidation allows the transportation network to be utilized more efficiently. It is very expensive to send ten pounds of product from New York to Houston, Tex. But if that ten pounds of product is combined with 500 other shipments of ten pounds each, the resulting 5000 pounds shipment can be moved very economically from New York to Houston. Freight consolidators pull in multiple small shipments and send it to either a retailer's distribution center 18, as represented by links 28 in FIG. 1, or to a retail outlet 22, as represented by link 30.

Still another scenario represented in FIG. 1 is one in which a supplier 14 may send product directly from its distribution or manufacturing facility to the retailers in the store, generally referred to as “direct store distribution,” or “DSD.” DSD is represented by link 32 in FIG. 1.

Three additional scenarios are represented in FIG. 1. In some cases, as represented by link 34, a proprietary manufacturer 12 may bypass outsourcing manufacturer 14 and ship product directly to a freight consolidator 24. Alternatively, manufacturer 12 may ship directly to a retail distribution center 18, as represented by link 36, or in some cases, directly to stores 22, as represented by link 38.

With continued reference to FIG. 1, each of the links shown therein represent significant areas for which a system in accordance with the presently disclosed embodiment of the invention may be advantageously applied. A first category of transaction to which the presently disclosed embodiment of the invention may be advantageously applied is that in which product is shipped to a retailer's distribution center 18. It is believed that this is a particularly critical stage of the overall supply chain 10.

An illustrative example of this is the apparel industry. Retailers receive product from a variety of manufacturing vendors 12 or outsourcing vendors 14 that re-sort products that they outsource. Additionally, retailers may have product supplied from freight consolidation entities, such that instead of receiving numerous small shipments, they receive one shipment consisting of goods from multiple vendors.

In many cases, there is a set of rules pertaining to the manner in which product is segregated, identified and individually packed, marked and prepared for the selling point. In accordance with a significant aspect of the present invention, a system in accordance with the present invention provides a platform for tracking these rules, maximizing compliance with those rules, and imposing penalties for failures to follow those rules. There is not presently believed to be any other application or software package that stands alone today that performs all three measurements of accuracy. That is, in the prior art, there is not known to the inventors to be a system that (1) monitors the way the freight moves in accordance with the freight rules, (2) monitors the actual quality content of any specific shipment, (3) generates the paperwork and identification of those shipments; and (4) measures violations against a set of rules and issues chargebacks specific to those violations.

Consider an example relating to the issue of freight movement. Most recipients of product have made arrangements with particular transportation providers for particular points of origin. A recipient will negotiate agreements with shipping companies to haul product to the recipient's distribution center on the shipping companies' trucks. Such agreements typically provide for rate structures which may be favorable relative to rates charged by other transportation providers. The recipient establishes rules, usually in writing, and instructs all of its vendors to utilize shipping companies. When the freight arrives at the distribution center 18, it comes in with a freight bill identifying the point of origin, the destination, the identity of the shipping company, and such data as the weight of the freight in the shipment.

A vendor may send a shipment via a different carrier than that specified according to the distributor's rules, i.e., a carrier with which the distributor has not negotiated a rate. This constitutes a compliance violation; the distributor must in that case pay for inbound freight rate at a higher rate than it would otherwise have, had the vendor used the carrier specified by the recipient's rules. For that violation, the recipient will create a compliance event to deduct from the cost of the goods on that truck. The deduction may correspond, for example, to the incremental freight cost plus a punitive damage fee, or any other fee at the discretion of the recipient.

Those of ordinary skill in the art will appreciate several advantages to a recipient establishing rules relating to the particular carriers to be used. Essentially, the carrier has agreed to the recipient's preferred manner of doing business. Such factors as the time of day that the carrier arrives at the recipient's distribution center, the volume of freight the carrier moves in any given shipment, and the discounted rate to move that freight, may be involved. And the majority of times these relationships achieve other beneficial results. The recipient may specify, for example, such details as whether trucks will be front-loaded or top-loaded, whether the truck will be brick-loaded or not, whether the truck will be netted, whether and how the freight will be segregated within the truck, how and when the associated paperwork will be sent, how and when the truck will be scheduled with your distribution center hours in advance, and so on. When freight comes in from other carriers from that point of origin, it can cause the recipient significant problems.

Different rules stratify every origin point in the country, every weight classification and then within weight classification, the commodity type. Establishing rules enable recipients to run efficient in-bound transportation networks, allowing the distribution facility to operate at optimal efficiency, and allowing the recipient to pay the least amount to move goods from any origin point to your destination. When a supplier does not follow those rules, it causes the recipient problems.

A system in accordance with the presently disclosed embodiment of the invention monitors the entire movement based on the rules, and recognizes occurrences of rules violations, such as when a vendor fails to utilize the specified carrier based on the origin point, the commodity type and the weight or perhaps even the time of day or perhaps even the time of month. For example, recipients create rules to optimize their transportation reports. An example would be a rule specifying that a carrier is not to ship to the recipient more than twice a week. A carrier following the rules would know to accumulate all of the shipments it is going to have to the recipient and deliver them in a maximum two trucks per week. The rule may further specify that if the carrier has no choice but to send more than two trucks, the carrier must obtain prior authorization from the recipient to send a third truck, giving the recipient an opportunity to prepare for the anomalous shipment.

In accordance with one significant aspect, a system generally in accordance with the present invention advantageously eliminates the need for a human being at a distribution center to manually track and monitor transactions and detect compliance events. Instead, the system monitors product flow over time and is able to evaluate, given any specific sets of information, whether rules violations have occurred.

In one embodiment, a system in accordance with the present invention takes as input the rules that established to make a supply chain efficient, and empowers or drives an audit function referred to herein as a “Directed Audit.” In a Directed Audit, a system in accordance with the present invention will identify, based on the commodity type and the identity of the vendor supplying the commodity, the most important rules to check. For example, it may be the case that a particular vendor has been found, over time, to be repeatedly in violation of a particular compliance rule. In such a case, applying the concept of a Directed Audit, a system in accordance with the present invention will recognize such a pattern or history of non-compliance and operate to ensure that a check of the applicable compliance rule is made for all transactions involving the repeat offender. Likewise, a system in accordance with the present invention may recognize a pattern of consistent compliance with a particular rule on the part of a particular vendor, and as part of the Directed Audit function, determine that a check of the particular rule is not necessary for transactions involving that vendor.

As part of a Directed Audit function, a system in accordance with the present invention may, for any given transaction, direct a person to verify compliance with, for example, the ten most important rules that should have been followed. The compliance information may then be captured and sent back to a central database.

In accordance with another aspect of the invention, a system in accordance therewith might allow some flexibility in terms of compliance. Different rules may be established for different commodity types. A computer manufacturer, for example, may have strict rules for transactions involving disk drives and hard drives, i.e., how they must be packed, labeled, and serialized, but a less strict set of rules to be applied to transactions involving bulk quantities of wiring. Likewise, in a retail setting, transactions involving shoes may have a different set of rules than those involving shirts. A system in accordance with the presently disclosed embodiment retains the rules, retains a past audit history and identifies trends in vendors' performance. For example, a system in accordance with the presently disclosed embodiment may determine, based on analysis of historical data, that a given vendor has a predisposition to committing a given violation. Accordingly, the system will generate instructions as part of the Directed Audit to have all transactions involving this vendor monitored for the specific type of violation. In this manner, the Directed Audit allows the user of the system to focus its energies more efficiently on the complying vendors. On the other hand, if a vendor has a proven track record vis-a-vis a particular rule, the system may provide for less frequent checks for violations of the rule in question for transactions involving that vendor. That is, based on historical performance, under the Directed Audit algorithm, the number of compliance checks made can be minimized through elimination or reduction in the number of checks relating to transactions involving vendors having a history of compliance. If a rules violation is found, the system records that mistake; the next time a transaction involving that particular commodity occurs, the Directed Audit algorithm will indicate the need for a check as to compliance with the previously violated rule(s) to ensure that the problem is not repeated. The Directed Audit is an historical algorithm based on commodity type and compliance failure.

Summary of Software Functionality

The compliance management software in accordance with the presently disclosed embodiment of the invention comprises a plurality of cooperating functional modules. It is believed that those of ordinary skill in the art of computer science having the benefit of the present disclosure will be readily able to develop such software based upon the following functional descriptions of these various modules.

Automatic Chargeback Review

The Automatic Chargeback Review module is a tool set that compares each record in an enterprise's receiving system, payables system, on all purchase orders, and all item files for any deviation from the established rules, in order to create recovery income. The Automatic Chargeback Review process looks for such violations as late shipments, early shipments, improper fill rates, improper discount terms or other improper pricing, and substitution errors. Upon detection of such violations, the Automatic Chargeback Review system generates a chargeback.

Automatic chargeback review involves reviewing the contractual portions of all supply chain transactions. Such contractual items are present in most retail organizations to facilitate the ordering, transportation, payment, and book creation of inventory. The compliance management system in accordance with the presently disclosed embodiment preferably is adapted to use a retailer's existing files and compares each item's value and performance to the retailer's rules list by linking the records together using the purchase order (“PO”) number, shipment number, freight bill number, check invoice, and deduction numbers. The system creates the compliance recovery, assigns a value, and writes to a file to passed to the retailer's accounts payable system.

In accordance with one aspect of the invention, the system preferably has the flexibility to value the compliance recovery charge using various metrics, including, for example, flat rates, percentages of cost purchases, fees per units processed, or some combination thereof. The system also preferably is adapted to be capable of set progressive amounts based on repeated failures on the part of a particular vendor.

After the recovery file is passed to the accounts payable system, the system monitors a “check file” to ensure that failures are taken on actual accounts payable checks. In addition to validating deductions, the system advantageously detects duplicate payments, missed discounts, and receipt over payment on all purchase orders.

The following example briefly illustrates the operation of the automatic chargeback review component of the compliance management system in accordance with the presently disclosed embodiment of the invention: The receiving system holds the amount of any given product received against any given purchase order. The system examines these totals for overages, shortages, and fill rate metrics in comparison to the retailer's tolerance for such exceptions. Similarly, the receiving system and procedures book inventory from a vendor shipment. These totals may then be compared to the original purchase orders for overages, substitutions and shortages. If exceptions are detected, compliance recoveries are created in line with the retailer's compliance rules.

Freight Routing Review

The Freight Routing Review module uses an enterprise's freight bills provided at the time of delivery of product. The Freight Routing Review process entails reviewing the origin point of every shipment and verifies that the correct carrier is used based upon the weight of the shipment, the ZIP code of the origin and destination locations, and commodity type. The process further allows for the reversal of freight costs for other content related problems, among other rules.

In one embodiment, freight bills are captured. The freight bills provide the system with the carrier scan code, weight, origin ZIP code, and shipping vendor for all shipments of goods for any purchase order. The system examines the freight bills and other relevant information to verify proper routing based upon the carrier preference stated in the recipient's rules for the weight level or origin zip code in question. In addition, if other content or timing-related compliance failures are identified, and the retailer links those failures to freight costs, the system will identify the correct freight charge for the purchase order and create the additional compliance recovery.

For example, a recipient may have a compliance rule specifying that multiple shipments are not allowed against a single purchase order, i.e., the order must ship complete. The receiving records for each purchase order are examined for any purchase order that has more than one receipt date. The second and subsequent shipments are identified and their freight costs are recovered by the automatic creation of a compliance recovery. This example illustrates a significant aspect of systems in accordance with the presently disclosed embodiment, in that it reveals how a recipient's compliance recovery may be significantly enhanced through automation of the compliance monitoring process. In the example, each individual shipment may be fully compliant with the recipient's compliance rules, such that no one shipment would trigger a compliance recovery. However, the shipments taken collectively are out of compliance with the “ship complete” rule, thus leading to a “hidden” recovery only detectable through automation of the monitoring process.

A recipient might further impose a rule specifying that shipments from a particular ZIP code weighing more than a specified amount, a specified carrier is to be used. The system in accordance with the presently disclosed embodiment of the invention evaluates the freight bills based on origin ZIP code, weight and carrier, and if a carrier other than that specified by the retailer's rules has been used, the freight costs are reversed to the vendor.

Freight Claims Management

The Freight claims Management modules manages claims based upon the enterprise's receiving system carton count and purchase order documentation to generate chargeback recovery income. Notices to carriers are automated, as is the valuation of shortages and damages. These tools provide a reference for the enterprise's accounts payable system to research short and open invoices.

Based on the capture of trailer profile data, the management system in accordance with the presently disclosed embodiment links the trailer profile data to all of the contained purchase orders, and the value and unit count of each purchase order. The system creates a notice of claim to be forwarded to the carrier, then waits for the purchase orders on the affected trailers to be cleared. The value of the claim is established and created to be forwarded to the carrier. The system tools monitor and uniquely track each open, pending, and resolved claim linked to the carrier profiles and contacts.

For example, a trailer may arrive at a recipient with two bills of lading each listing two purchase orders and carton counts. If one carton is found to be damaged, the purchase order is known and the claim process is relatively simple. On the other hand, if another carton is determined to be missing but cannot be tied to a single purchase order on the trailer, the system waits for all of the purchase orders to close, calculates the average units per carton on the trailer and the average value of each carton, providing the necessary information to file a compliance recovery claim.

Audit Engine

The Audit Engine uses the historical performance of an enterprise's vendor base and optimizes the use of audit resources by focusing effort toward known and repeat offenders and their known problems, while at the same time preferably maintaining an overall random sample approach for all vendors. The audit process may be radio-frequency (RF) based and paperless, so as to minimize errors and facilitate real-time compliance failure identification.

The audit engine is based on the physical verifications that shipments contain the product as ordered on the purchase order, and that all labeling rules were followed by the vendor. These categories of compliance rules are preferably monitored using several different types of audits, typically conducted by the distribution center audit staff, as well as through product handling that normally takes place in the course of product movement. If a recipient uses electronic data interchange (EDI) transactions, the audit approach and physical procedure can be enhanced and made faster. All audits and exceptions are automatically examined in comparison to the retailer's rules.

The audit engine optimizes the audit effort in three principal ways: First, as noted above, the audit engine directs audits to vendors that have historically been observed to have had compliance violations. Second, for any given vendor, the audit engine focuses on specific failure issues that the specific vendor has experienced in the past. Third, each question set is related on a dynamic basis to previous answers in the audit, since the audit is conducted to avoid inquiries and assessments that are no longer relevant; further, the sample size of the audit may be based on the accuracy of previous assessments.

For example, the freight check-in portion of a shipment examines packing slips for accuracy and completeness utilizing a standard questionnaire (or audit) to capture shipment characteristics data. After this data is entered into the compliance management system, the system compares each audit to the recipient's rules. Utilizing radio-frequency (RF) hand-held scanners, audits may be conducted on the contents of individual cartons for verification of UPC symbols against the purchase order. Checking for price, size, color, and style may be automated and the data obtained using the RF scanner can be compared to the recipient's rules for content errors.

Trouble Tracking

The Trouble Tracking module is a software tool set for objectively tracking and managing trouble freight by aging outstanding issues and assigning reason codes for both the original problems and their resolutions. The Trouble Tracking application is preferably structured to follow the buyer organization chart and highlight recurring issues and real cycle times for resolution.

Trouble shipments are identified in the distribution center. In order to maintain control of this freight, a unique number is assigned to each “trouble.” The form captures key information and reason codes, allowing communication of this information to buyers in a uniform manner for resolution. Each of the resolutions completes a loop that tracks new purchase orders and shipment tracking numbers. Troubles that have not been resolved are tracked, and each trouble is linked by the department to the correct buyer, vendor, and carrier. Aging reporting coupled with reason code tracking provide for permanent fixes to ongoing issues. Each trouble reason code is compared to the retailer's compliance rules to ensure that vendor-caused troubles are identified and the appropriate compliance recovery is associated with the original purchase order and any new purchase orders or shipments issued to resolve the problem. In addition, following resolution, reporting is created to show the distribution center's progress of the order to ensure that the product is reintroduced into the recipient's product flow.

For example, if trouble freight (i.e., goods that are unable to be processed due to incorrect, incomplete, or inconsistent information and hence is segregated from the remainder of a shipment) arrives under an invalid purchase order number, the buyer may issue a new purchase order. However, the original trouble form and the manual violation audit will carry the invalid purchase order number. The resolution process captures the new purchase order number, and the compliance management system links the compliance failure and creates a compliance recovery. The reporting of troubles is also corrected and the problem is linked to the new purchase order number.

Correspondence Management

The Correspondence Management application facilitates the aging and automatic research of vendor inquiries to minimize the extent that the emotions and personalities of those involved interfere with the correspondence process as it relates to chargebacks and the like. Using the Correspondence Management application, all elements of the overall receivable and compliance management system have access to the same research and status data for all vendor issues.

Correspondence management allows for efficient responses to vendor and buyer questions regarding specific compliance charges or trends. A compliance management system in accordance with the presently disclosed embodiment automates the collection of various transactions into a single research tool. Audits, freight, purchase orders, shipment checks, and terms are present in real-time for each query, with the correct related buyer and vendor contact information. The system may also incorporate additional data and notes from the recipient's existing systems to enhance the research.

If, for example, a vendor calls regarding a deduction on a particular payment for a certain amount, information about the deduction can be accessed using either a deduction number printed on the check, or the check number itself. Information about the related compliance charge and all back-up documentation relating thereto can be retrieved and printed quite efficiently. Each received vendor research package is recorded and assigned a tracking ID. Cycle times for research and aging by vendor allows vendors with large issues to get priority resolution. Status on research is maintained and available on demand.

Reporting and Exception Management

A critical component of the overall system, the Reporting and Exception Management module comprises a comprehensive and open reporting tool for deriving and generating meaningful information out of the supply chain data. Cross-functional reporting can be used to measure and quantify true vendor, data capture, and organization performance. Vendors can be managed at the departmental level, allowing the greatest flexibility to satisfy the true value of individual relationships while attaining the objective of broad and complete vendor compliance.

The reporting component of a compliance management system in accordance with the presently disclosed embodiment allows data sets that would be unrelated in prior art management systems to be assimilated in a central location to enable the creation of cross-functional management tools. The utilization of the retailer's buying hierarchy at the departmental level allows for all compliance transactions to be reported at various summary levels. The construction of the reporting mechanism at the departmental level allows purchase orders and shipments to be linked to the correct buyers. This also advantageously allows for the performance of vendors to be reported and exemptions to be managed at the departmental level by buyer. A profile is maintained for each vendor and transportation provider, centralizing the contacts into one structure related in any individual shipment or audit. Individual terms can be maintained by vendor number.

Consider a case where a vendor provides product to four buyers in eight departments out of three of the vendor's production facilities. If the vendor is unable to comply with one rule from one facility affecting two departments and two buyers, exemptions can be established in those departments while the vendor is still liable for compliance charges in all other departments.

Further, a vendor that supports multiple buyers in similar product categories may have different performance issued based on the way a particular buyer creates its purchase orders. The vendor performance hierarchy established in the management system in accordance with the presently disclosed embodiment allows for overall cost purchase, audit, compliance and freight reporting for that vendor within that one department or at a summary level for that buyer.

Reporting relating to transportation providers includes data for damaged goods, freight bill pick-up dates, trouble shipments for early or invalid purchase orders, such that true performance reports for the transportation providers can be generated to demonstrate how efficient the carrier is in accepting only valid freight and how long the product is in transit prior to delivery to the retailer.

Data Sources

The following table outlines the relationship between the various software modules comprising the system in accordance with the presently disclosed embodiment and the various sources of data available to the system.

| FUNCTIONALITY | COMPLIANCE MANAGEMENT TOOLS | RECIPIENT SOURCE DATA |
|---|---|---|
| Automatic Chargeback | Database structure | Purchase orders |
| Review | Chargeback Review Engine | Shipping data |
| | Chargeback Verification Tool | Vendor compliance standards |
| | Accounts Payable Audit Tool | Check receipts/payment history |
| | Compliance Recovery Valuation | Vendor profiles |
| | Compliance Recovery Filtration | |
| Freight Routing Review | Freight Bills Capture Tool | Shipping data |
| | Routing Review Engine | Vendor routing rules |
| | Vendor Compliance Failure Link | |
| Freight Claims Management | Trailer Profile Capture | Purchase orders |
| | Freight Bills Capture | Shipping data |
| | Claim Creation and Tracking Tool | Vendor profiles |
| Audit Engine | Radio-frequency Audit Engine | Purchase orders |
| | Paperwork and Labeling Audits | Vendor compliance standards |
| | Manual Violation Audits | EDI |
| | Vendor Performance History Database | Item file |
| Trouble Tracking | Trouble Forms Capture | Merchandising hierarchy - |
| | Trouble Aging Tools | recipient buying organization |
| | | Purchase orders |
| | | Shipping data |
| Correspondence | Research Engine | Check receipts/payment history |
| Management | Correspondence Aging Tools | Merchandising hierarchy - |
| | Vendor Performance History Database | Recipient Buying Organization |
| | Vendor Contact Tracking Tools | Purchase orders |
| | Notes Collection Tool | Shipping data |
| | | Vendor profiles |
| Reporting and Exception | Vendor Exemption Tool | All data |
| Management | Vendor Performance History Database | |

Overview of System Architecture—Recipient Component

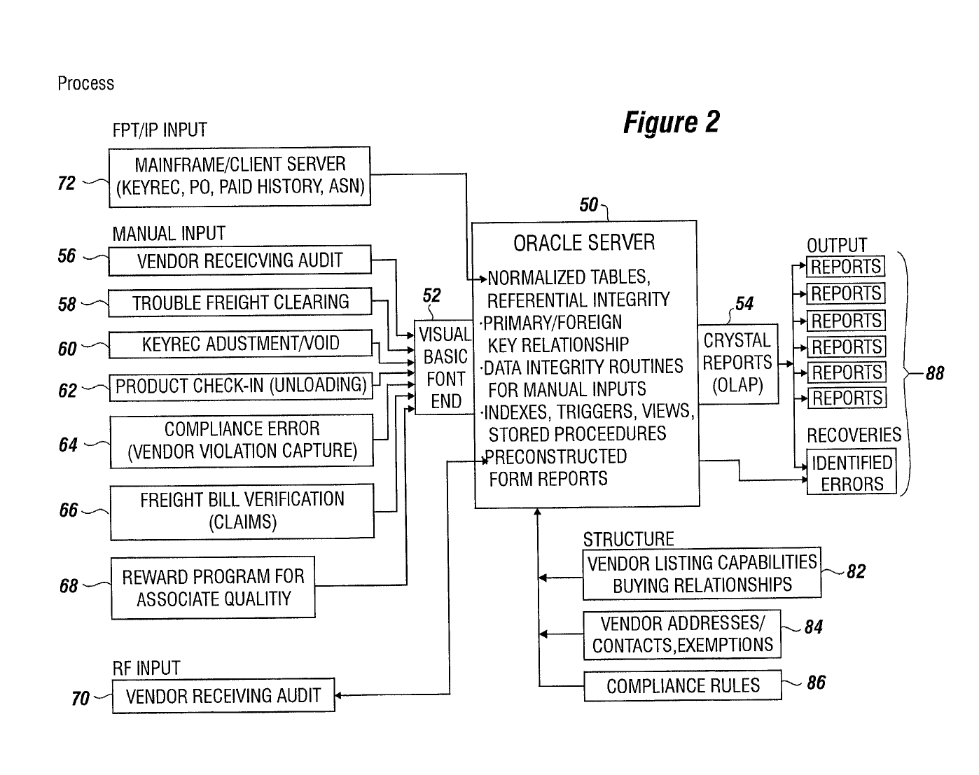

Referring to FIG. 2, there is shown a block diagram illustrating the various components comprising a software-based compliance management system in accordance with the presently disclosed embodiment of the invention. As shown in FIG. 2, at the heart of the system is a system server 50 upon which most of the software processes are executed. In one embodiment, server 50 is implemented as an Oracle database server.

Associated with server 50 is a “front end” 52 adapted to function as an interface between server 50 and various sources of input. In one embodiment, front-end 52 is implemented in the Visual Basic and C++ programming languages, and facilitates the manual and automated inputting of information relating to a recipient's transactions.

Also associated with server 50 is a report module 54 for generating reports in accordance with the presently disclosed embodiment. In one embodiment, report module 54 is an on-line analytical processing (OLAP) module, as would be familiar to those of ordinary skill in the art.

In accordance with one aspect of the invention, it will be appreciated by those of ordinary skill in the art that the various components of the system 10 depicted in FIG. 1 may be physically disposed at locations remote from one another. In one embodiment, for example, the transactional information captured by a user of the system may be gathered at one location and transmitted, for example, by means of a local area network, wide area network, or even the Internet, to a processing facility upon which database server 50 is executed. That is, it is not necessary in accordance with the invention for the overall compliance management system to be collectively disposed at a single location, and those of ordinary skill in the computing arts will appreciate how system distribution may be advantageously realized.

The compliance management system in accordance with the presently disclosed embodiment is essentially an information capture and storage process that is adapted to be layered beneath recipient's existing information systems (i.e., financial systems, distribution and warehouse systems, merchandising systems and the like). In accordance with one aspect of the invention, the management system provides a standalone process for the centralized capture of supplier compliance information from data input processes that are already implemented in most distribution centers. Within server 50, this information can then be related to compliance guidelines and summarized, for example, by supplier. The system preferably identifies failures not noted through normal distribution center manual scanning processes and provides a tool to conduct comprehensive research into supplier compliance issues.

Among the processes that already exist in most distribution centers are: sender receiving audit processes (represented by block 56 in FIG. 2), trouble freight clearing processes (block 58), KeyRec adjustment processes (block 60) for adjusting information relating to goods which are received, product check-in and analysis processes (block 62), compliance error detection processes (block 64), freight bill verification processes (block 66), and quality control processes (block 68). As can be observed in FIG. 2, each of these existing processes represents a source of input data provided to server 50 through front-end 52. In one embodiment, vendor receiving information may also be provided directly to server 50 from a hand-held RF scanner, as represented by block 70 in FIG. 2. Finally, KeyRec, purchase order, payment history and ASN data may be provided to server 50 by means of an FTP/IP link between server 50 and the recipient's purchase order/accounts payable system, as represented by block 72 in FIG. 2.

With continued reference to FIG. 2, server 50 must also have access to a listing of the recipient's vendors, as represented by block 82, vendor contacts and exemption information, as represented by block 84, and, importantly, the retailer's compliance rules, as represented by block 86. Supplied with this information, server 50 is thereby capable of processing all transaction-specific input data (blocks 56-72) to detect compliance violations based on these rules. After processing the data, reporting module can then generate the desired reports, represented by blocks 88.

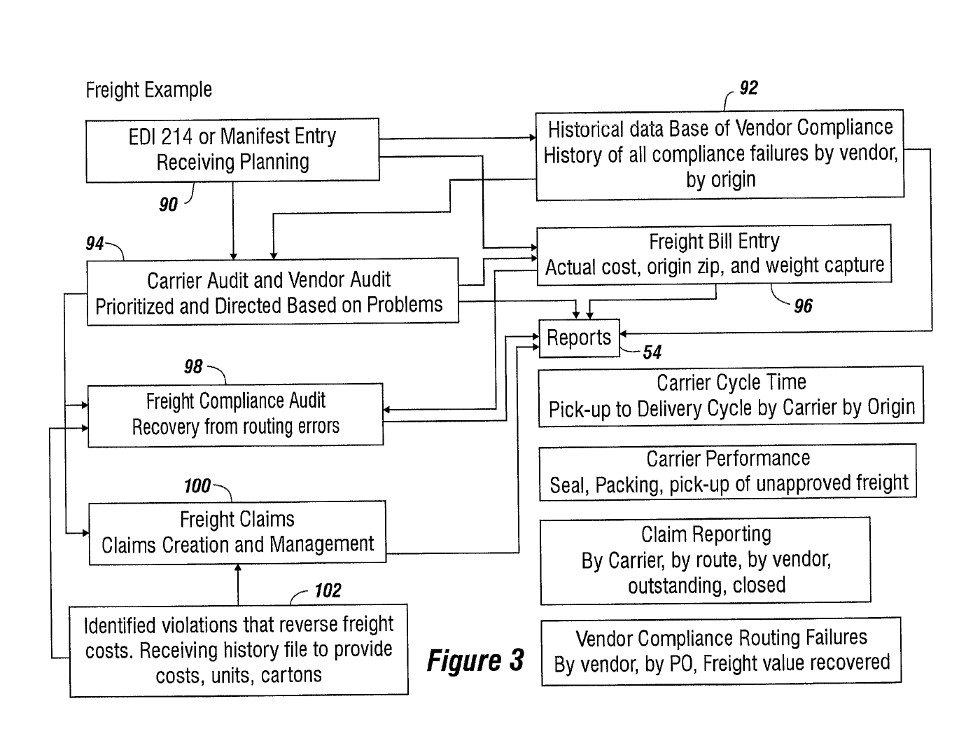

Turning to FIG. 3, there is shown a flow diagram illustrating operation of the compliance management system in accordance with the presently disclosed embodiment of the invention. A starting point for the process will be a source of information about a particular transaction, as represented by block 90. This source may be EDI214 data, a freight manifest, bill of lading or the like. This information is used to index into a historical database of vendor compliance, as represented by block 92, such that the system can retrieve data representing the history of all compliance failures by vendor or origin. The transaction data is also provided to the carrier audit and vendor audit processes, in block 94, in which prioritized and directed audit functions are applied to the data. The directed audit is formulated based upon input from historical database process 92, as described above.

Transaction data is likewise provided to a freight bill entry process, for capturing data relating to actual transaction costs, freight origin, and freight weight, as represented by block 96. This captured data, in turn, is provided to a freight compliance audit process, represented by block 98. The results of the carrier audit and vendor audit are likewise provided to the freight compliance audit process 98 and to a freight claims process 100.

Any identified violations that would result in reversal of freight costs back to the vendor are identified in block 102 and this information is provided to the freight compliance audit process 98 and to the freight claims process 100. The freight claims process 100 is responsible for creating and managing freight compliance claims.

The outputs from all functional processes in the compliance management system are ultimately provided to reporting component 54 for generation of reports. Examples of the types of reports that may be generated include, without limitation, reports on carrier cycle time (pick-up to delivery, sorted by carrier and/or by origin), carrier performance (seal, packing, pick-up of unapproved freight), claim reporting (sorted by carrier, by route, by vendor, and/or by status), and vendor compliance routing failures (sorted by vendor, by origin, by purchase order, and/or by freight value recovered). All such reports constitute valuable resources for the vendor in monitoring and maximizing the efficiency and cost-effectiveness of its business.

Overview of System Architecture—Vendor Component

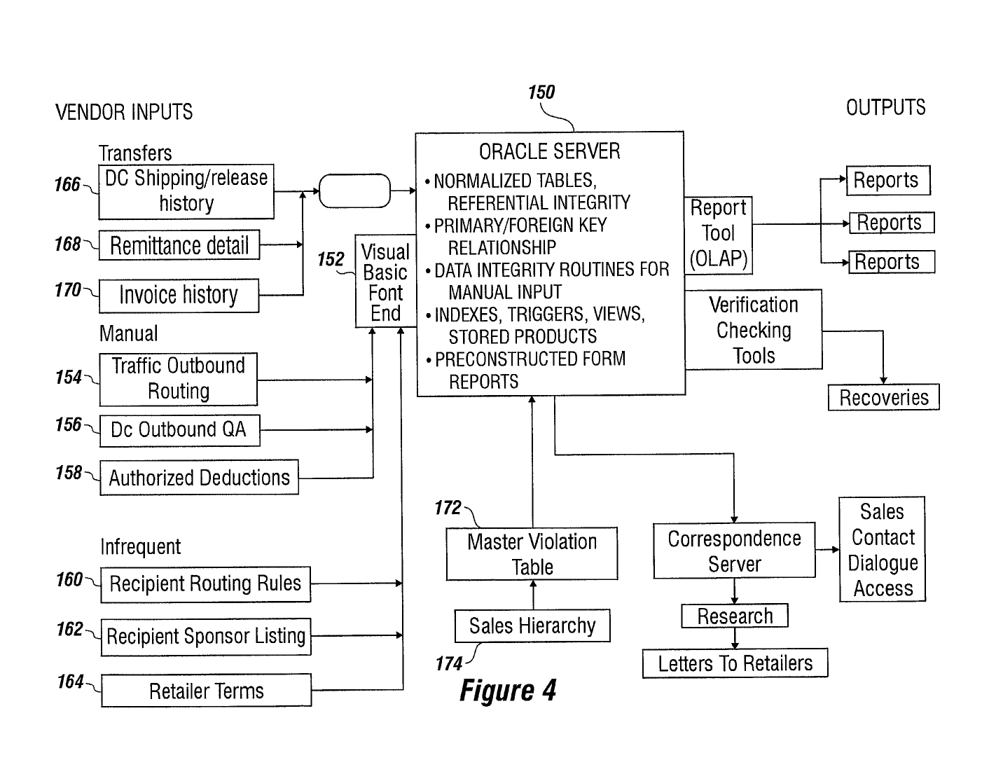

As noted previously, in addition to the recipient component of the compliance management system for maximizing compliance recovery due to vendor non-compliance, it is contemplated that in one embodiment, the present invention may further comprise a vendor-side component for minimizing vendors' expenses or losses incurred as a result of compliance penalties imposed by the recipients to which they supply product. FIG. 4 is a block diagram illustrating the system architecture of such a vendor-side component in accordance with one embodiment of the present invention.

Referring to FIG. 4, the vendor-side component is based upon a central server 150, just as the recipient-side component is based on central server 50. In one embodiment, central server 150 is an Oracle database server. As in the recipient-side component, central server 150 in the vendor-side component takes data from a plurality of processes as input, processes and analyzes the data, and generates reports and other tools usable by the vendor in the management of its compliance processes.

A front-end module 152 is provided to serve as an interface between the data-providing processes and central server 150. In the presently disclosed embodiment, front-end module 152 is implemented in the Visual Basic and C++ programming languages. Among the inputs to server 150 via front-end 152 are traffic outbound routing information, represented by block 154 in FIG. 4, distribution center outbound quality assurance data represented by block 156, authorized deduction data represented by block 158, recipient routing rules represented by block 160, retailer sponsor data represented by block 162, and recipient terms information represented by block 164.

Also provided to central server 150 is distribution center shipping/release history data, remittance data, and invoice history data, represented by blocks 166, 168, and 170, respectively. In the preferred embodiment, a master violation table is maintained accessible by central server 150, as represented by block 172. The master violation table comprises a listing of all compliance rules upon the vendors by the retailers to which the vendors supply product. Finally, sales hierarchy data represented by block 174 is provided to server 150. Those of ordinary skill in the art will understand that sales hierarchy data includes such information as the vendor's sales organization, product lines, and so forth.

Overview of System Architecture—Recipient Component

As herein described, it will be apparent to those of ordinary skill that implementation of a system in accordance with the disclosed embodiment of the invention results in the automatic or semi-automatic generation of a recovery income stream based upon the issuance of charge-backs to those participants in the supply chain determined to be in violation of one or more compliance rules. The codification and automatic monitoring of transactional events in a supply chain enable a user to realize quantifiable economic benefits which would not be as likely realized absent the functionality of the inventive system. That is, the present invention provides a practitioner with the opportunity to benefit from otherwise untapped resources to enhance the economic productivity associated with participation in a supply chain.

As is apparent from the foregoing description, the present invention is preferably and advantageously implemented in the form of computer software adapted to be executed upon a hardware platform maintained, most commonly, by a participant in a supply chain. Such a software-based system supplants the processes that have been, in the prior art, performed in a considerably less systematic manner, by personnel charged with monitoring rules compliance. Another significant aspect of the invention relates to the manner in which the software implementing the disclosed system may be commercially distributed.

In one embodiment, software implementing the functionality herein described may be distributed at low or no cost to participants in a supply chain who are positioned to economically benefit from the recovery income-generating outcomes of the inventive system. That is, a vendor of software in generally accordance with the disclosed embodiment may offer the software to customers at no cost, whereas such sophisticated software might normally be sold or licensed a premium rates. In exchange, and in accordance with one aspect of the invention, the software vendor may structure a software license or sale in such a manner as to share in the economic recovery income stream generated as a result of the implementation of the licensed software. For example, a practitioner of the invention may offer software providing the functionality substantially as herein described in exchange for a certain percentage of the charged-back amounts realized through operation of the system. A practitioner of the invention may further provide hardware upon which to run the inventive software, as well as training and support for the end-users, at on a similarly low- or no-cost basis, recovering the costs for these items similarly through sharing in the recovery income stream generated by operation of the system.

Assuming that appropriate balances can be met, it is likewise contemplated that a practitioner of the invention may offer to provide not only the software as herein described, but also the computer hardware necessary for a supply chain participant to fully implement the compliance management system. Those of ordinary skill in the art having the benefit of the present disclosure will appreciate that such arrangements are made possible principally through the recovery income-generating nature of the disclosed invention.

From the foregoing detailed description of a specific embodiment of the invention, it should be apparent that a system for monitoring and tracking vendor compliance with predetermined guidelines for the manufacture, shipment, and receipt of goods has been disclosed. Although a specific embodiment of the invention has been disclosed herein in some detail, this has been done solely for the purposes of illustrating various aspects and features of the invention, and is not intended to be limiting with respect to the scope of the invention. It is contemplated that various substitutions, alterations, modifications and/or additions, including but not limited to those design alternatives which might have been specifically noted in this disclosure, may be made to the disclosed embodiment without departing from the spirit and scope of the invention as defined in the claims which follow.

What is claimed is:

1. A method for deriving recovery income within a distribution supply chain comprising a plurality of transactional events facilitating the conveyance of said goods from a supplier to an end recipient, comprising:
(a) establishing a plurality of compliance rules governing transactional events within said supply chain;
(b) defining a monetary penalty to be imposed on a party to a transactional event upon non-compliance with each said compliance rule;
(c) codifying said compliance rules within a computer-based system;
(d) monitoring said supply chain to detect non-compliance events;
(e) providing information regarding detected non-compliance events to said computer-based system;
(f) automatically generating, from said computer-based system, non-compliance charge-backs to be communicated to those parties within the supply chain upon whom said monetary penalties are to be imposed in accordance with said compliance rules.

2. A method in accordance with claim 1, further comprising:
(g) automatically generating reports of non-compliance events.

3. A method in accordance with claim 1, wherein said step (d) of monitoring said supply chain comprises performing a directed audit of transactional events in said supply chain to detect violations of said compliance rules.

4. A system for monitoring compliance with a plurality of rules governing transactional events within a supply chain, comprising:
a computer processing unit having a data store upon which at least one file encoding said plurality of rules is stored;
at least one input device for providing transactional information to said processing unit;
wherein said processing unit is adapted to execute a process whereby said transactional information is assessed for compliance with said plurality of rules;
and wherein said processing unit is further adapted to automatically generate non-compliance charge-backs upon detection of a transaction failure in which at least one of said plurality of rules is violated in a given transaction.

5. A method of commercial distribution of computer software, where the execution of said software results in generation of a recovery income stream, comprising, on the part of a distributor of said software:
providing a computer-readable copy of said computer software for execution by a participant in a supply chain;
charging said participant a software license fee proportional to said recovery income stream.

6. A method in accordance with claim 5, further comprising, on the part of the distributor, providing computer hardware suitable for executing said software.

7. A method in accordance with claim 5, wherein said software tracks compliance with rules imposed upon participants in a distribution supply chain.

8. A method of monitoring and enforcing compliance with rules imposed by a participant in a distribution supply chain upon transactional events occurring in said supply chain, comprising:
(a) for each transactional event to occur, providing transactional information concerning such event to a computer-based system having said rule codified therein;
(b) assessing said transactional information to identify violations of said rules;
(c) for each violation detected in step (b), automatically generating from said computer-based system a transaction chargeback reflecting a penalty to be imposed upon a party to said transactional event responsible for said violation.

9. A method in accordance with claim 8, wherein said step (a) of providing transactional information comprises entry of said information using a computer keyboard.

10. A method in accordance with claim 8, wherein said step (a) of providing transactional information comprises transmission of scanned information transmitted by radio-frequency.
